(19) United States
(12) Patent Application Publication
(10) Pub. No.: US 2024/0308546 A1
(43) Pub. Date: Sep. 19, 2024

(54) DRIVING THREAT ANALYSIS AND CONTROL SYSTEM BASED ON DRIVING STATE OF ADVANCED DRIVER ASSIST SYSTEM AND METHOD THEREOF

(71) Applicant: Nat'l Yunlin University of Science and Technology, Douliu City (TW)

(72) Inventor: Ben-Jye CHANG, Douliu City (TW)

(21) Appl. No.: 18/122,125

(22) Filed: Mar. 16, 2023

(51) Int. Cl. B60W 60/00; B60W 30/08; B60W 30/16; H04W 4/40

(52) U.S. Cl. CPC B60W 60/0025; B60W 30/08; B60W 30/16; H04W 4/40; B60W 2554/80; B60W 2556/45

(57) ABSTRACT

A driving threat analysis and control system based on a driving state of advanced driver assist system and a method thereof. A vehicle cloud based on cloud computing and mobile edge computing is applied to minimize and avoid dangerous and unstable driving action or self-driving vehicle (SDV); the CAP between a target vehicle and a front vehicle is applied to solve the problem that ACC easily generates a large number of state transitions, by collection of big data prediction of driving state information and 5G eV2X. The driving states of high-threat areas are analyzed by using 3-level cloud computing mechanism to reduce driving threats and realize active and safe driving of self-driving vehicles and assisted driving vehicles. Therefore, the efficiency of avoiding and preventing automated driving collisions and ensuring the safety of platooning vehicles driving autonomously can be achieved.

### BACKGROUND

### 1. Technical Field

The present invention is related to an analysis control system and a method thereof, more particularly to a driving threat analysis and control system based on driving state of advanced driver assist system and a method thereof.

### 2. Description of the Related Art

In 5G sidelink, the enhanced-vehicle-to-everything (eV2X) is specified to support the vehicle-to-anything communication of internet of vehicles (IoV) via 5G, and the cellular V2X of IoV is defined for the applications of autonomous-self driving (ASD) and 5 levels of advanced driver assistance systems (ADAS), so as to achieve active safe driving.

Since diverse applications of IoV, ADAS and the fully autonomous-self driving generate different types of flows for different driving states requiring different QoS, different types of flow slicing (such as emergency, eV2X, uRLLC, eMBB, and mMTC) are dynamically formed as service function chaining (SFCs), to achieve real-time ultra reliable low delay communications among vehicles to share the driving states of ADAS of the adaptive cruise control (ACC), the lane departure warning/assistant (LDW/LDA), and vehicle platooning (CAP).

According to above-mentioned contents, what is needed is to develop an improved solution to solve the problem that the existing autonomous-self driving vehicle platooning system may occur driving collision accidents.

### SUMMARY

An objective of the present invention is to disclose a driving threat analysis and control system based on driving state of advanced driver assist system and a method thereof, to solve the conventional problem that the existing platooning vehicles still happen driving collision accidents.

In order to achieve the objective, the present invention provides a driving threat analysis and control system based on driving state of advanced driver assist system, wherein the driving threat analysis and control system is adapted to a vehicle communicating via 5G, include a definition and classification module, a threshold setting module, a threshold calculation module and a control message transmission module.

The definition and classification module is configured to define and classify a driving state of each of advanced driver assistance systems (ADAS) based on sensed and gathered information of a neighbor vehicle. The threshold setting module is configured to set a minimum safe distance between a target vehicle and a front vehicle, wherein the minimum safe distance and vehicle-following information of the target vehicle and the front vehicle are set as dynamic thresholds of the ADAS of the neighbor vehicle. The threshold calculation module is configured to provide the dynamic thresholds to a lane departure warning (LDW) system and a lane departure assist (LDA) system, map a multiple-lane road to a single-lane road, determine a logical distance, switch the target vehicle and the front vehicle for using the same algorithm to determine optimal dynamic thresholds of the LDW system and the LDA system. The control message transmission module is configured to control velocities of all vehicles of platooning vehicles by group-casting a control message to another vehicle of the platooning vehicles via 5G enhanced-vehicle-to-everything (eV2X) communication.

In order to achieve the objective, the present invention provides a driving threat analysis and control method based on driving state of advanced driver assist system, and the driving threat analysis and control method includes steps of: defining and classifying a driving state of each of advanced driver assistance systems (ADAS) based on sensed and gathered information of a neighbor vehicle, by the vehicle; setting a minimum safe distance between a target vehicle and a front vehicle, by the vehicle, wherein the minimum safe distance and a vehicle-following information of the target vehicle and the front vehicle are set as dynamic thresholds of the ADAS of the neighbor vehicle; providing the dynamic thresholds to a lane departure warning (LDW) system and a lane departure assist (LDA) system, mapping a multiple-lane road to a single-lane road, determine a logical distance, switching the target vehicle and the front vehicle for using the same algorithm to determine optimal dynamic thresholds of the LDW system and the LDA system, by the vehicle; controlling velocities of all vehicles of a platooning vehicles by group-casting a control message to another vehicle of the platooning vehicles via 5G enhanced-vehicle-to-everything (eV2X) communication, by the vehicle.

According to the above-mentioned system and method of the present invention, the difference between the present invention and the conventional technology is that a vehicle cloud based on cloud computing and mobile edge computing is applied to minimize and avoid dangerous and unstable driving action or self-driving vehicle (SDV), the CAP between the target vehicle and the front vehicle is applied to solve the problem that ACC easily generates a large number of state transitions, by collection of big data prediction of driving state information and 5G eV2X; the driving states of high-threat areas are analyzed by using 3-level cloud computing mechanism to reduce driving threats and realize active and safe driving of self-driving vehicles and assisted driving vehicles.

Therefore, the above-mentioned solution of the present invention is able to achieve the efficiency of avoiding and preventing automated driving collisions and ensuring the safety of platooning vehicles driving autonomously.

### BRIEF DESCRIPTION OF THE DRAWINGS

The structure, operating principle and effects of the present invention will be described in detail by way of various embodiments which are illustrated in the accompanying drawings.

FIG. 1 is a block diagram of a driving threat analysis and control system based on driving state of advanced driver assist system, according to the present invention.

FIG. 2 is a coloring analysis diagram of ACC, LDW/LDA and CAP based on driving states of ADAS, according to the present invention.

FIG. 3A is a diagram showing driving states of ACC, according to the present invention.

FIG. 3B is a diagram showing driving states of LDW/LDA, according to the present invention.

FIG. 3C is a diagram showing driving states of CAP, according to the present invention.

FIG. 4A is a diagram showing transitions of high and low priority states, according to the present invention.

FIG. 4B is a diagram showing transitions of high and low priority states, according to the present invention.

FIG. 4C is a diagram showing numbers of transitions of high and low priority states of LDW when a direction signal is turned on, according to the present invention.

FIG. 4D is a diagram showing numbers of transitions of high and low priority states of LDW when the direction signal is turned off, according to the present invention.

FIG. 5A and FIG. 5B are flowcharts of a driving threat analysis and control method based on driving state of advanced driver assist system, according to the present invention.

### DETAILED DESCRIPTION

The following embodiments of the present invention are herein described in detail with reference to the accompanying drawings. These drawings show specific examples of the embodiments of the present invention. These embodiments are provided so that this disclosure will be thorough and complete, and will fully convey the scope of the invention to those skilled in the art. It is to be acknowledged that these embodiments are exemplary implementations and are not to be construed as limiting the scope of the present invention in any way. Further modifications to the disclosed embodiments, as well as other embodiments, are also included within the scope of the appended claims.

These embodiments are provided so that this disclosure is thorough and complete, and fully conveys the inventive concept to those skilled in the art. Regarding the drawings, the relative proportions and ratios of elements in the drawings may be exaggerated or diminished in size for the sake of clarity and convenience. Such arbitrary proportions are only illustrative and not limiting in any way. The same reference numbers are used in the drawings and description to refer to the same or like parts. As used herein, the singular forms “a”, “an” and “the” are intended to include the plural forms as well, unless the context clearly indicates otherwise.

It is to be acknowledged that, although the terms ‘first’, ‘second’, ‘third’, and so on, may be used herein to describe various elements, these elements should not be limited by these terms. These terms are used only for the purpose of distinguishing one component from another component. Thus, a first element discussed herein could be termed a second element without altering the description of the present disclosure. As used herein, the term “or” includes any and all combinations of one or more of the associated listed items.

It will be acknowledged that when an element or layer is referred to as being “on,” “connected to” or “coupled to” another element or layer, it can be directly on, connected or coupled to the other element or layer, or intervening elements or layers may be present. In contrast, when an element is referred to as being “directly on,” “directly connected to” or “directly coupled to” another element or layer, there are no intervening elements or layers present.

In addition, unless explicitly described to the contrary, the words “comprise” and “include”, and variations such as “comprises”, “comprising”, “includes”, or “including”, will be acknowledged to imply the inclusion of stated elements but not the exclusion of any other elements.

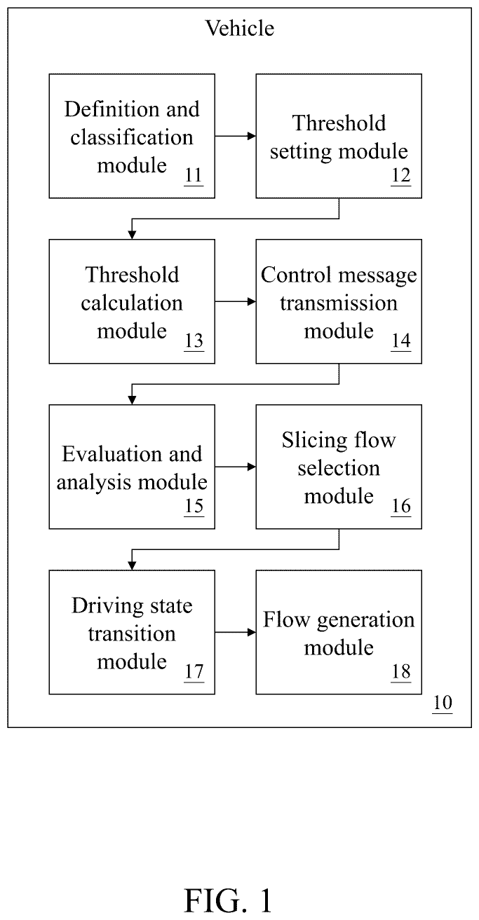

A driving threat analysis and control system based on driving state of advanced driver assist system of the present invention will be illustrated in the following paragraphs. Please refer to FIG. 1, which is a block diagram of a driving threat analysis and control system based on driving state of advanced driver assist system, according to the present invention. As shown in FIG. 1, the driving threat analysis and control system is adapted to a vehicle 10 communicating via 5G, and includes a definition and classification module 11, a threshold setting module 12, a threshold calculation module 13 and a control message transmission module 14.

The definition and classification module 11 is configured to define and classify a driving state of each advanced driver assistance systems (ADAS) based on sensed and gathered information of a neighbor vehicle. The threshold setting module 12 is configured to set a minimum safe distance between a target vehicle and a front vehicle, wherein the minimum safe distance and vehicle-following information of the target vehicle and the front vehicle are set as dynamic thresholds of the ADAS of the neighbor vehicle. The threshold calculation module 13 is configured to provide the dynamic thresholds to a lane departure warning (LDW) system and a lane departure assist (LDA) system, map a multiple-lane road to a single-lane road, determine a logical distance, switch the target vehicle and the front vehicle for using the same algorithm to determine optimal dynamic thresholds of the LDW system and the LDA system. The control message transmission module 14 is configured to control velocities of all vehicles of platooning vehicles by group-casting a control message to another vehicle of the platooning vehicles via 5G enhanced-vehicle-to-everything (eV2X) communication.

In an embodiment, the vehicle 10 can include an evaluation and analysis module 15, a slicing flow selection module 16, a driving state transition module 17, and a flow generation module 18.

The evaluation and analysis module 15 is configured to evaluate analysis efficiency of coloring for an adaptive cruise control (ACC), the lane departure warning (LDW), and a cooperative adaptive cruise control (CACC) and a cooperative autonomous platooning (CAP) system based on the driving state of the ADAS and a driving threat (AAT) mechanism. The slicing flow selection module 16 is configured to use different slicing flow priority for a change of the driving state of different ADAS for the vehicle. The driving state transition module 17 is configured to change the driving state of the ADAS in real time when the driving state of the ADAS is changed from a state i to a state j. The flow generation module 18 is configured to generate a uRLLC-Dangerous flow or a uRLLC-Warning flow via 5G enhanced-vehicle-to-everything (eV2X) when the driving state of the dynamic thresholds of the ADAS, the CACC, the LDW and the CAP is changed to a dangerous state in red color or a warning state in yellow color.

The present invention proposes several different ADAS states of driving analyses for coloring and classifying driving threat, and the analyzed ADAS states of driving threats are then timely announced to the vehicle and neighbor vehicles that are going to have the potentially possible driving threats. The announced transmission modes can be in broadcasting, group-casting or unicasting mode. As a result, the present invention is able to effectively avoid and prevent from happening the driving collision accidents, and further apply to five levels ADAS and autonomous self-driving (ASD) vehicles as well as form an adaptive active safe driving (AASD) for every vehicle.

To analyze different driving states of diverse ADAS, the present invention proposes the driving threat coloring analyses, in which for each ADAS the driving states are defined and classified in three categories including a dangerous state in red color, a warning state in yellow color, and a safe state in green color based on the sensed and gathered information of individual ADAS of neighbor vehicles; however, these examples are just for illustration and the application field of the present invention is not limited thereto. The dangerous state in red color is also called Red_Dangerous, the warning state in yellow color is also called Yellow_Warning, and the safe state in green color is also called Green_Safe hereafter. The driving dynamic threshold between a dangerous area (or range) in red color and a warning area in yellow color is denoted by a, and the driving dynamic threshold between the warning area in yellow color and a safe area in green color is denoted by B.

Since the functionalities of different ADAS are different, each type of ADAS should exhibit individual thresholds α and β. It should be noted that dynamic thresholds α and β of ADAS are not standardized, because any types of parameters of a driving vehicle are dynamic changed.

In order to achieve the proposed dynamic coloring mechanism of the present invention in ACC, an ACC algorithm is proposed to adaptively determine the optimal dynamic thresholds α and β for ACC. First, for the determination of the dynamic threshold α in ACC, a minimum safe distance between a target vehicle and a front vehicle is defined as d_{i,j}^{ACC,α}, which is defined as the dynamic threshold α for ACC.
d_{i,j}^{ACC,α} is determined by the equation as below:

$${d}_{i , j}^{ACC , α} ( t ) = {d}_{resp} ( t ) + {d}_{brake} ( t )$$

dᵣₑₛₚ(t) denotes a response distance required for a human driver (i.e., for ADAS levels 1-3) or a detection distance of ASD vehicle (i.e., for ADAS levels 4-5) as well as d_{brake}(t) denotes a brake distance at time; dᵣₑₛₚ(t) denotes a response distance, and dᵣₑₛₚ(t) is determined by the equation as below:

$${d}_{resp} ( t ) = {t}_{i}^{ACC} \cdot {v}_{i}^{r , ℓ} ( t )$$

[symbol] (t) denotes the response time or the detection time tᵢ^{ACC} of ACC, (e.g., 0.01 sec, but this example is just for illustration and the application field of the present invention is not limited thereto), times the velocity Vⁱ of the target vehicle.

For d_{Brake}, the inter-vehicle safe distance between two adjacent vehicles is set as [symbol] Since different roads have different friction coefficients (u^{r,l}), they result in different forces of friction (denoted by u^{r,l}gᵢ), where gᵢ is the acceleration constant of gravity. Thus, the brake distance d_{brake}(t) can be determined by the equation as below:

$${d}_{brake} ( t ) = ( \frac{{v}_{i}^{r , ℓ} ( t )}{2} ) ( \frac{{v}_{i}^{r , ℓ} ( t )}{{u}^{r , l} {g}_{i}} )$$

Consequently, the minimum safe distance d_{i,j}^{ACC,α} of the dynamic threshold α can be formulated by the equation as below:

$${d}_{i , j}^{ACC , α} ( t ) = \frac{{{v}_{i}^{r , ℓ} ( t )}^{2}}{2 {u}^{r , l} {g}_{i}} + {t}_{i}^{ACC} \cdot {v}_{i}^{r , ℓ} ( t )$$

After the dynamic threshold α in ACC is determined, the dynamic threshold β is determined according to the vehicle-following information. The dynamic threshold β is related to stability of the target vehicle Vⁱ driving related to its precedent (front) vehicle V^{j} such as a relative velocity and a relative acceleration. Based on Kinematics of a particle trajectory, after the target vehicle Vⁱ is decelerated and the relative velocity is adjusted to 0, that is [symbol] (t+Δt)=0, the adjustment time (t_{Δdj} or Δt) can be determined as below.

$$0 = {v}_{i , j}^{r , ℓ} {(}^{t} - 2 \cdot {a}_{i , j}^{r , ℓ} ( t ) \cdot {d}_{Adj}$$

$$i . e . , {v}_{i , j}^{r , ℓ} {(}^{t} = 2 \cdot {a}_{i , j}^{r , ℓ} ( t ) \cdot {d}_{Adj}$$

$${( \frac{{d}_{i , j}^{r , ℓ}}{Δ t} )}^{2} = 2 \cdot {a}_{i , j}^{r , ℓ} ( t ) \cdot {d}_{Adj}$$

$$∴ Δ t = {t}_{Adj} = \sqrt{\frac{{d}_{i , j}^{r , ℓ}}{2 \cdot a ( t ) \cdot {d}_{Adj}}} or \sqrt{\frac{{( {d}_{i , j}^{r , ℓ} )}^{2}}{{{v}_{i}^{r , ℓ} ( t )}^{2}}}$$

The adjustment distance d_{Adj}^{i,j}(t) is obtained by the equation as below,

$${d}_{Adj}^{i , j} ( t ) = {t}_{Adj}^{i , j} \cdot {v}_{j}^{r , ℓ} ( t ) .$$

Thus, the dynamic threshold β (that is, d_{i,j}^{ACC,β}) is determined by the equation as below,

$${d}_{i , j}^{ACC , β} ( t ) = {d}_{i , j}^{ACC , α} ( t ) + {d}_{Adj}^{i , j} ( t )$$

In ACC, when the inter-vehicle distance is smaller than d_{i,j}^{ACC,β} and larger than d_{i,j}^{ACC,α} the target vehicle Vᵢ enters into the warning area in yellow color. In summary, the determined ACC states are detected and classified as,

$$\{ \begin{matrix}if ( {d}_{i , j}^{ACC} ( t ) < {d}_{i , j}^{ACC , α} ) , the ACC state is Red Dangerous , \\ if ( {d}_{i , j}^{ACC , α} ( t ) \leq {d}_{i , j}^{ACC} ( t ) < {d}_{i , j}^{ACC , β} ( t ) ) , the ACC state is Yellow Warning \\ if ( {d}_{i , j}^{ACC} ( t ) \geq {d}_{i , j}^{ACC , β} ( t ) ) , the ACC state is Green Safe\end{matrix} ,$$

In a condition that the velocity of the target vehicle Vᵢ is [symbol] (t)=65(km/hr)=18.05(m/s); that of the front vehicle is [symbol] (t)=50(km/hr)=13.88(m/s), the dynamic thresholds α and β are calculated as below,

$${d}_{i , j}^{ACC , α} ( t ) = \frac{{( 18.05 )}^{2}}{1 \cdot 10} + ( 0.01 ) \cdot ( 18.05 ) = 32.76 m$$

$${d}_{i , j}^{ACC , β} ( t ) = 39.83 + ( 13.88 ) \cdot 2.21 = 70.504 m$$

In LDW/LDA, the target vehicle Vⁱ demanding to change to the right lane or the left lane should turn on the directional change signal before action. With the LDW/LDA ADAS, the target vehicle Vⁱ can avoid collision by receiving the LDW alarm message of lighting, sounding, or light vibration of power steering, when there are some vehicles in the lane that the target vehicle to be changed to.

The present invention proposes a dynamic coloring mechanism for LDW/LDA to adaptively determine the optimal dynamic thresholds α and β for LDW/LDA. Initially, to efficiently simplify the LDW/LDA algorithm, a multiple-lane road is mapped into a single lane road and a logical distance is determined. The physical distance (denoted by d_{i,j}^{LDW,Phy}) between the target vehicle Vⁱ in a lane l and the rear vehicle V^{j} in a lane l+1 is larger than the logical distance d_{i,j}^{LDW,Log}. For maximizing the LDW/LDA safety, the shorter logical distance d_{i,j}^{LDW,Log} is adopted in the mapped single-lane road model. The logical distance d_{i,j}^{LDW,Log} can be determined by the equation as below,

$${d}_{i , j}^{LDW , Log} ( t ) = \sqrt{{{d}_{i , j}^{LDW , Phy} ( t )}^{2} - {( {W}_{r , i} )}^{2}}$$

W_{r,l} denotes the lane width of the lane l on the road r.

In LDW/LDA, the target vehicle Vⁱ is in front of the rear vehicle V^{j}, so in LDW/LDA the two vehicles should be switched for using the same ACC algorithm, to determine the optimal dynamic thresholds α and β for LDW/LDA. That is, in LDW/LDA the rear vehicle of V^{j} is re-denoted as V^{m} and the front vehicle of Vⁱ is re-denoted as Vⁿ. The optimal dynamic thresholds α and β for LDW/LDA can be obtained by the equations as below,

$${d}_{m , n}^{LDW , Log , α} ( t ) = \frac{{{v}_{m}^{r , ℓ + 1} ( t )}^{2}}{2 {u}^{r , l} {g}_{m}} + {t}_{i}^{LDW} \cdot {v}_{m}^{r , ℓ + 1} ( t )$$

$${d}_{m , n}^{LDW , Log , β} ( t ) = {d}_{m , n}^{LDW , Log , α} ( t ) + {d}_{Adj}^{m , n} ( t )$$

d_{Adj}^{m,n}(t) denoting the adjustment distance is determined by the equation as below,

$${d}_{Adj}^{m , n} ( t ) = {t}_{Adj}^{m , n} \cdot {v}_{n}^{r , ℓ} ( t )$$

[symbol] (t) and [symbol] (t) denoting the velocity of the rear vehicle V^{j} (i.e., the re-denoted V^{m}) on lane l+1 and that of the front vehicle Vⁱ (i.e., the re-denoted Vⁿ or the target vehicle) on lane l, respectively. The velocity of the rear vehicle V^{j} (i.e., V^{m}) on the lane l+1 can be determined by the target vehicle Vⁱ (i.e., Vⁿ or the target vehicle) on the lane l by using the relative velocity formula, i.e., [symbol] (t)← [symbol] (t)−v_{i,j}^{r}(t).

The determined LDW/LDA states are detected and classified as below,

$$\{ \begin{matrix}if ( {d}_{i , j}^{LDW , Log} ( t ) < {d}_{m , n}^{LDW , Log , α} ) , the LDW state is Red Dangerous , \\ \begin{matrix}if ( {d}_{m , n}^{LDW , Log , α} ( t ) \leq {d}_{i , j}^{LDW , Log} ( t ) < {d}_{i , j}^{LDW , Log , β} ( t ) ) , \\ the LDW state is Yellow Warning\end{matrix} \\ if ( {d}_{i , j}^{LDW , Log} ( t ) \geq {d}_{m , n}^{LDW , Log , β} ( t ) ) , the LDW state is Green Safe\end{matrix} ,$$

In CAP, a platooning group of vehicles is dynamically formed by the first-order most-front leader vehicle of the platooning and the other following member vehicles. The CAP ADAS is proposed to avoid yielding driving shockwave due to asynchronous acceleration or brake. Specifically, for a platooning vehicles, the leader controls the velocity for all member vehicles by group-casting the control message to the platooning via 5G eV2X communication, so that the member vehicles synchronously increase or decrease the velocity. Thus, in CAP, the ACC in ADAS is operated by the platooning leader and CAP in ADAS is operated in each platooning member vehicle. Specifically, first, the platooning leader V^{leader} adopts ACC to guarantee the safely driving in Green Safe state between the platooning the front precedence vehicle. The inter-vehicle distance between the platooning leader V^{leader} and the front vehicle V^{j} should be larger than the dynamic threshold d_{leader,j}^{ACC,β}(t). The velocity of the platooning V^{leader} is thus determined by the equation as below,

$${v}_{leader}^{r , ℓ} ( t ) = \frac{{d}_{leader , j}^{ACC , β} ( t ) - {d}_{leader , j}^{ACC} ( t )}{{t}_{i}^{ACC}}$$

Each platooning member adopts CAP to keep the stable driving velocity between itself and the front member vehicle to achieve synchronously acceleration and brake controlling via 5G eV2X communication. After receiving the group-casting platooning message from the platooning leader V^{leader}, each platooning member vehicle Vⁱ first determines the deviation of acceleration [symbol] (t) between the platooning leader V^{leader} and this member vehicle Vⁱ by the equation as below,

$${a}_{i , l}^{r , ℓ} ( t ) = {k}_{a} ( t ) \cdot ( {v}_{leader}^{r , ℓ} ( t ) - {v}_{i}^{r , ℓ} ( t ) ) , {k}_{a} ( t ) > 0$$

k_{α}(t) denotes the rate of speed deviation for acceleration and is set to a constant of 0.4 (1/sec.). At time t, the platooning member Vⁱ determines the velocity at time t+1 based on the velocity of the front member vehicle Vⁱ⁻¹ at time t, as shown in the equation as below,

$${v}_{i}^{r , ℓ} ( t + 1 ) = {v}_{i}^{r , ℓ} ( t ) + {k}_{p} {d}_{i , i - 1}^{gap} ( t ) + {k}_{s} {v}_{i , i - 1}^{CAP} ( t )$$

kₚ is the control gains on the positioning and is set to 0.45 (1/sec.), kₛ is the control gains on speed deviations and is set to 0.25 that is not a unit, and d_{i,i-1}^{gap}(t) is the inter-vehicle distance gap between the platooning member vehicles Vⁱ and Vⁱ⁻¹ at time t.

The relative velocity of the platooning member vehicles Vⁱ and Vⁱ⁻¹ at time t+1 can be determined by the equation as below,

$${v}_{i , i - 1}^{CAP} ( t + 1 ) = {v}_{i - 1}^{r , ℓ} ( t ) - {v}_{i}^{r , ℓ} ( t + 1 ) - {t}_{i}^{CAP} \cdot {a}_{i , leader}^{r , ℓ} ( t )$$

[symbol] (t) is the deviation of acceleration between the platooning leader V^{leader} and this member vehicle Vⁱ; tᵢ^{CAP} is the platooning synchronous period, such as 1 second; however, this example is just for illustration, and the application field of the present invention is not limited thereto.

As a result, the dynamic threshold α, i.e., dᵢ^{CAP,α}, of the platooning member vehicle vⁱ is determined by the equation as below,

$${d}_{i , i - 1}^{CAP , α} ( t + 1 ) = {v}_{i , i - 1}^{CAP} ( t + 1 ) \cdot {t}_{i}^{CAP} + {d}_{i , i - 1}^{gap} ( t )$$

The dynamic threshold β, i.e., dᵢ^{CAP,β} of the member vehicle Vⁱ is determined by the equation as below,

$${d}_{i , i - 1}^{CAP , β} ( t + 1 ) = {v}_{i , i - 1}^{CAP , α} ( t + 1 ) + {d}_{Adj}^{i , i - 1} ( t )$$

d_{Adj}^{i,i-1}(t) is the adjustment distance between platooning member vehicles Vⁱ and v^{i-1.}

As a result, the determined CAP states are determined and classified as below,

$$\{ \begin{matrix}if ( {d}_{i , i - 1}^{CAP} ( t ) < {d}_{i , i - 1}^{CAP , α} ( t ) ) , & the CAP state is Red Dangerous , \\ if ( {d}_{i , i - 1}^{CAP , α} ( t ) \leq {d}_{i , i - 1}^{CAP} ( t ) < {d}_{i , i - 1}^{CAP , β} ( t ) ) , & the CAP state is Yellow Warning , \\ if ( {d}_{i , i - 1}^{CAP} ( t ) \geq {d}_{i , i - 1}^{CAP , β} ( t ) ) , & the CAP state is Green Safe\end{matrix}$$

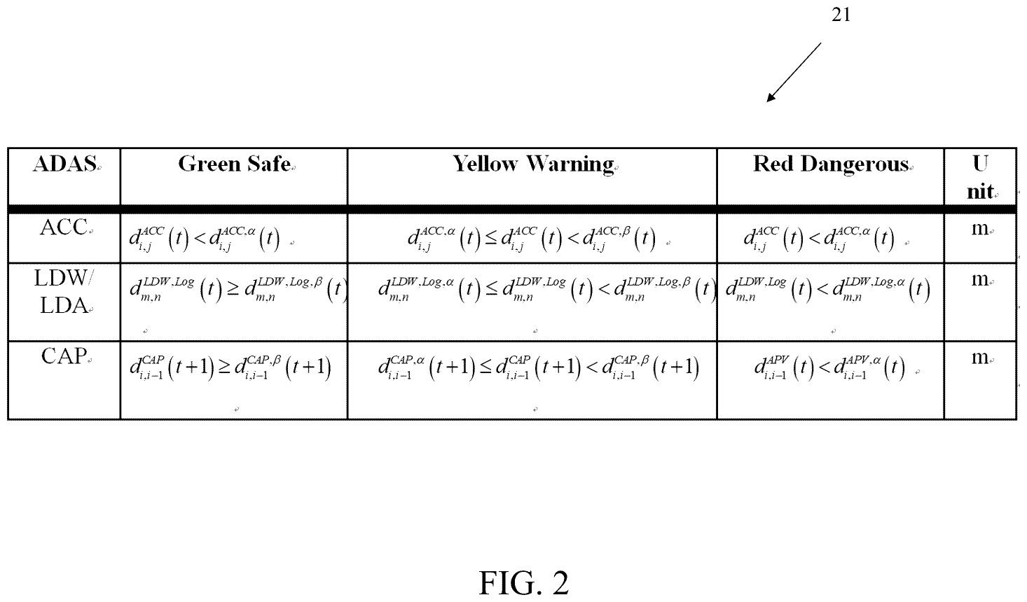

The dynamic thresholds 21 (α and β) of ADAS states coloring analyses of ACC, LDW/LDA, and CAP are shown in FIG. 2, which is a coloring analysis diagram of ACC, LDW/LDA and CAP based on driving states of ADAS, according to the present invention.

The efficiency of the proposed ADAS states analysis for coloring and classifying driving threat (AAT) mechanism for ACC, LDB and CAP is evaluated.

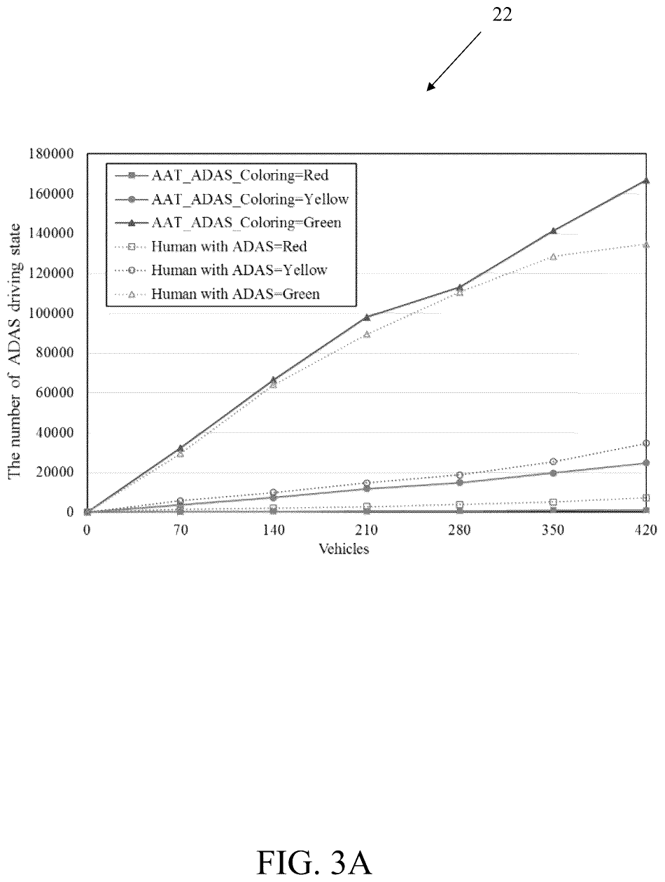

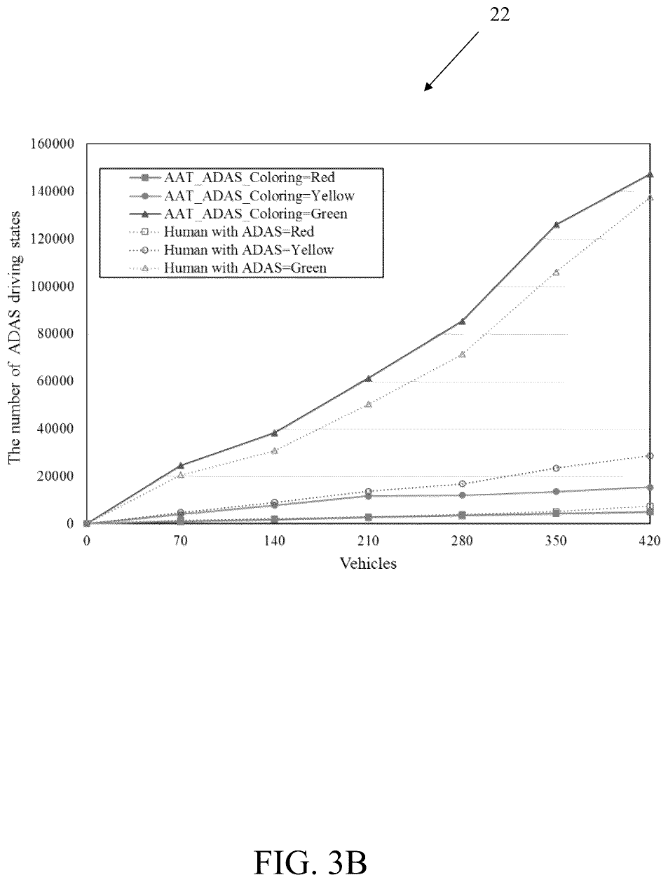

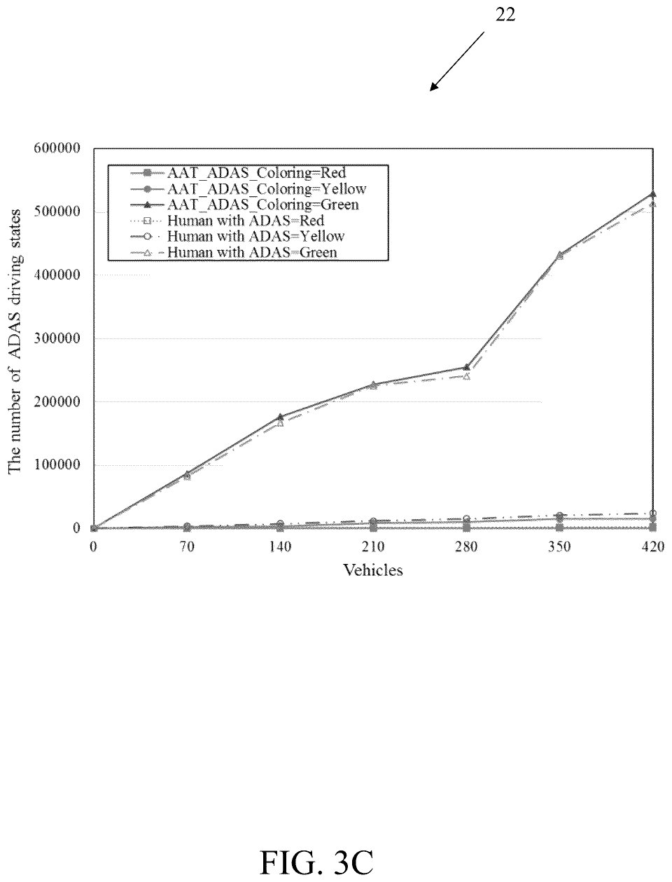

In an embodiment, the proposed AAT mechanism of ADAS with coloring analysis of dynamic thresholds α and β (namely AAT_ADAS_Coloring in FIG. 3A to FIG. 3C) and the human driver of L1-L3 ADAS (namely “Human with ADAS” in FIG. 3A to FIG. 3C) are compared under different numbers of vehicles ranging from 70 to 420 (vehicles). The performance metrics 22 of the ADAS states in Red_Dangerous, Yellow_Warning, and Green_Safe are compared, as shown in FIG. 3A to FIG. 3C. FIG. 3A is a diagram showing driving states of ACC, according to the present invention. FIG. 3B is a diagram showing driving states of LDW/LDA, according to the present invention. FIG. 3C is a diagram showing driving states of CAP, according to the present invention.

In FIG. 3A, the number of ADAS ACC driving states of AAT_ADAS_Coloring and “Human with ADAS” under different numbers of vehicles are evaluated, and all driving states in red, yellow, and green increase as the number of vehicles increasing. As shown in FIG. 3A, the proposed AAT_ADAS_Coloring of ACC generates the least number of Red_Dangerous states that is significantly lower than that of “Human with ADAS” of ACC. The reason is that the proposed AAT_ADAS_Coloring of ACC can affectively avoid the Red_Dangerous situation by adopting the dynamic thresholds α and β analyses. On the other hand, although the traditional ADAS of ACC also generates a lower number of red states, it suffers from the static ACC controlling.

As a result, AAT_ADAS_Coloring of ACC generates much lower number of Yellow_Warning states than that of “Human with ADAS” of ACC, AAT_ADAS_Coloring of ACC generates much higher number of Green_Safe states than that of “Human with ADAS” of ACC, so AAT_ADAS_Coloring of ACC obviously results in higher safe driving.

In FIG. 3B, the number of ADAS LDW/LDA driving states of AAT_ADAS_Coloring and “Human with ADAS” are evaluated, and all driving states of Red, Yellow, and Green increase as the number of vehicles increasing. As shown in FIG. 3B, the proposed AAT_ADAS_Coloring of LDW/LDA generates the least number of Red_Dangerous states that is obviously lower than that of “Human with ADAS” of LDW/LDA. Moreover, the conventional ADAS of LDW/LDA generates a lower number of Red states, but suffers from the static LDW/LDA controlling.

As a result, AAT_ADAS_Coloring of LDW/LDA causes a lower number of Yellow_Warning states than that of “Human with ADAS” of LDW/LDA, and AAT_ADAS_Coloring of LDW/LDA causes higher number of Green_Safe states than that of “Human with ADAS” of LDW/LDA, so AAT_ADAS_Coloring of LDW/LDA affectively increases the driving safety.

In FIG. 3C, the number of ADAS CAP (vehicle platooning) driving states of AAT_ADAS_Coloring and “Human with ADAS” are evaluated, and all driving states of Red, Yellow, and Green increase as the number of vehicles increasing. As shown in FIG. 3C, the driving states of CAP of AAT_ADAS_Coloring results in the lower number of Red_Dangerous and Yellow_Warning states, and leads to higher number of Green_Safe states

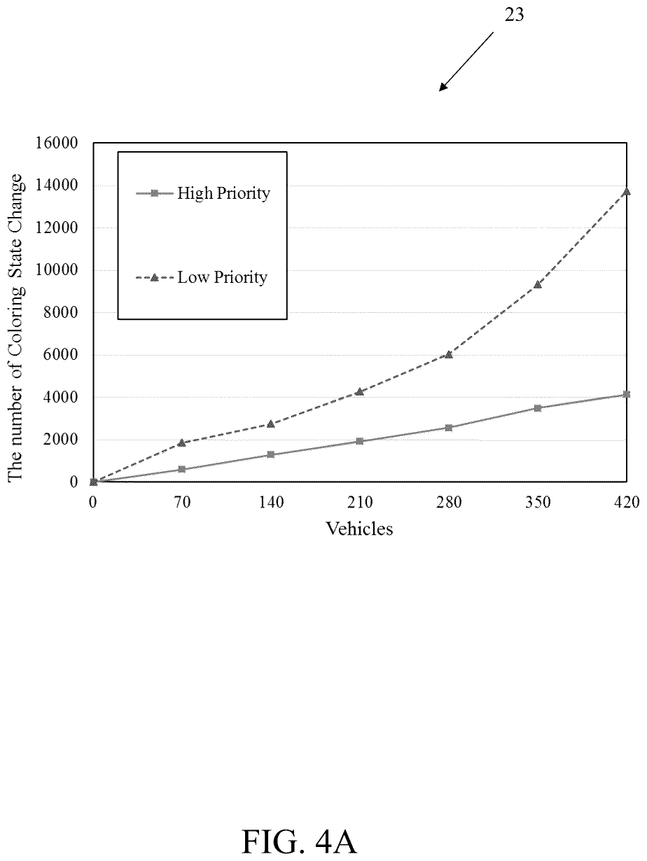

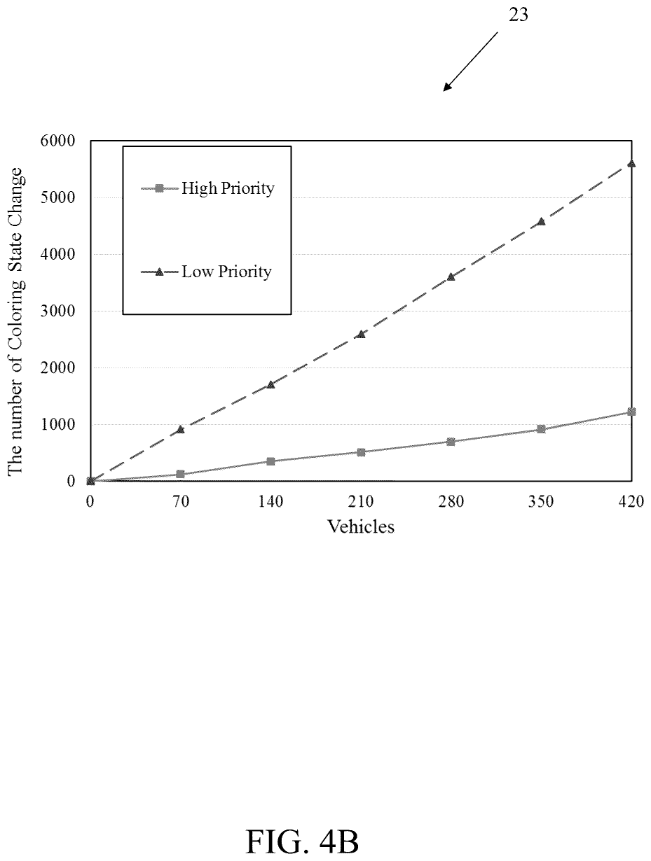

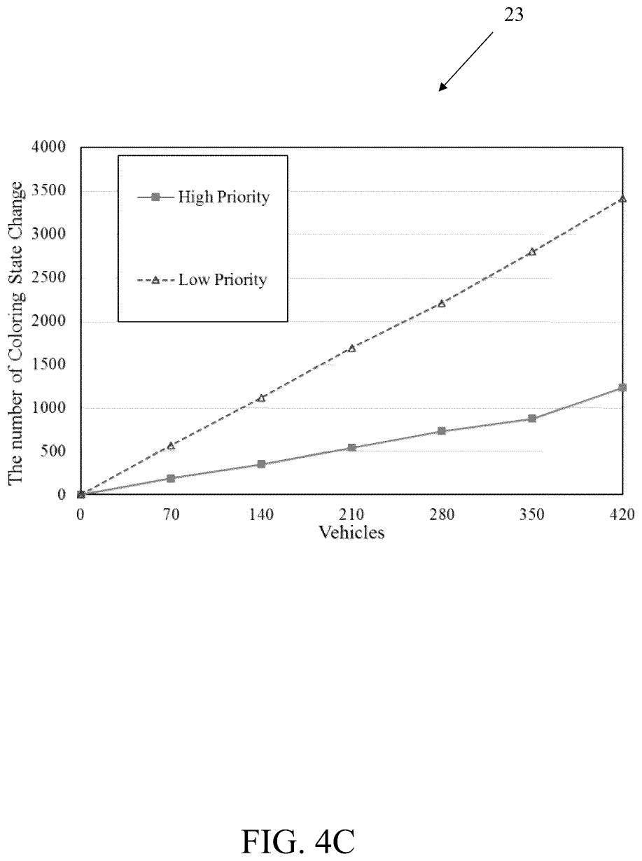

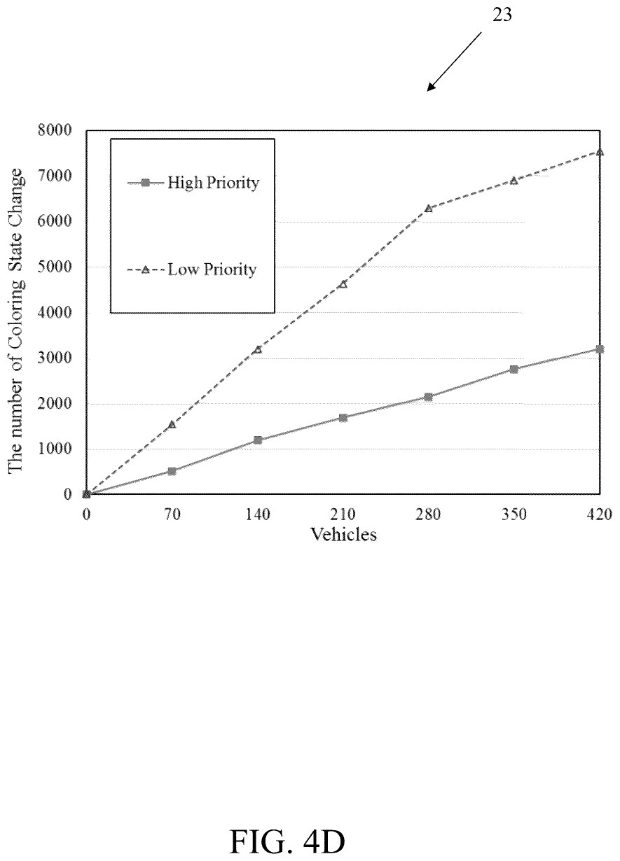

Please refer to FIG. 4A to FIG. 4D. FIG. 4A is a diagram showing transitions of high and low priority states, according to the present invention. FIG. 4B is a diagram showing transitions of high and low priority states, according to the present invention. FIG. 4C is a diagram showing numbers of transitions of high and low priority states of LDW when a direction signal is turned on, according to the present invention. FIG. 4D is a diagram showing numbers of transitions of high and low priority states of LDW when the direction signal is turned off, according to the present invention.

FIG. 4A to FIG. 4C show the evaluations of ADAS coloring threat state transitions 23 of high and low priorities slicing flows of ACC, LDW, and CAP. Each ADAS system generates a higher number of state transitions of high priority flow than that of low priority flow.

In FIG. 4A and FIG. 4B, CAP generates much lower number of state transitions in both high and low priorities flows than that of ACC. The reason is CAP exhibits the synchronous acceleration and brake for the platooning member vehicles, and thus results in a stable platooning driving and lower number of state transitions. Specifically, CAP efficiently brings a highly stable, safe, and efficient driving.

In FIG. 4C and FIG. 4D, the number of state transitions 23 of LDW with directional signal ON is obviously lower than that of LDW with a directional signal OFF. ACC generates a higher number of state transitions than LDW with signals ON and OFF, because the car following behavior of a driving vehicle is easily affected by the front vehicle actions.

As a result, ACC easily leads to high number of state transitions among CAP, LDW with signals ON and OFF, and leads to high driving threat probability and unsafe. It should be noted that ACC can be improved by using CAP between these two independent vehicles of the target vehicle and the precedence front vehicle via the 5G eV2X communication.

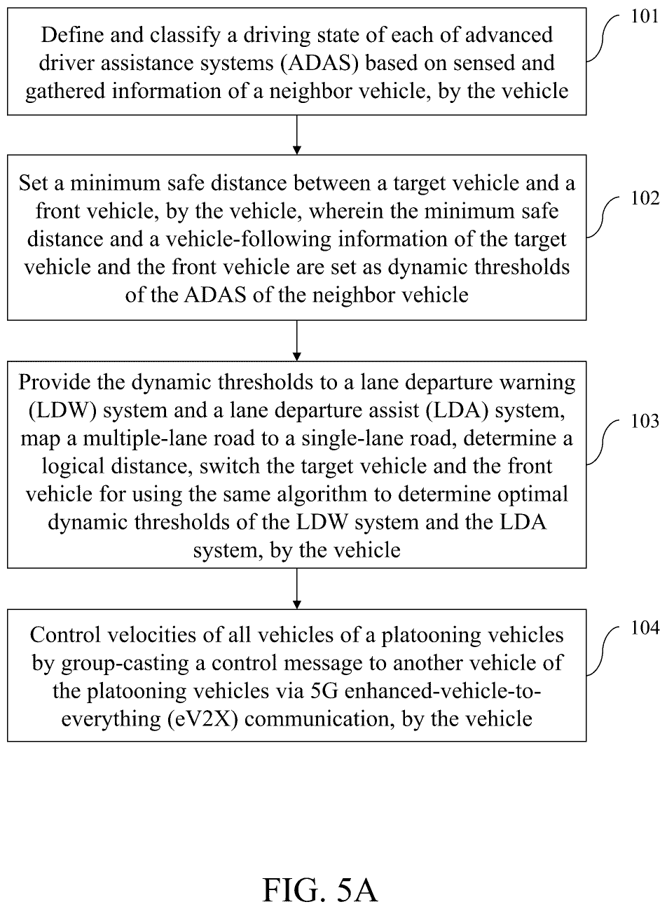

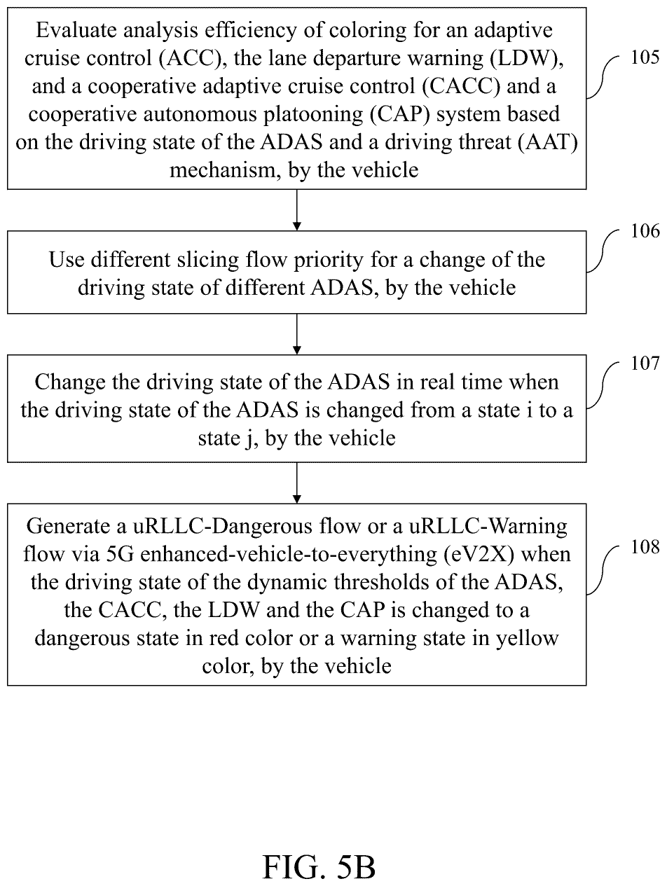

The operation of the method of the present invention will be illustrated in the following paragraphs. Please refer to FIG. 5A and FIG. 5B, which are flowcharts of a driving threat analysis and control method based on driving state of advanced driver assist system, according to the present invention.

As shown in FIG. 5A and FIG. 5B, the driving threat analysis and control method is adapted to a vehicle communicating via 5G, and includes the following steps.

In a step 101, the vehicle defines and classifies a driving state of each of advanced driver assistance systems (ADAS) based on sensed and gathered information of a neighbor vehicle. In a step 102, the vehicle sets a minimum safe distance between a target vehicle and a front vehicle, wherein the minimum safe distance and a vehicle-following information of the target vehicle and the front vehicle are set as dynamic thresholds of the ADAS of the neighbor vehicle. In a step 103, the vehicle provides the dynamic thresholds to a lane departure warning (LDW) system and a lane departure assist (LDA) system, maps a multiple-lane road to a single-lane road, determine a logical distance, switches the target vehicle and the front vehicle for using the same algorithm to determine optimal dynamic thresholds of the LDW system and the LDA system. In a step 104, the vehicle controls velocities of all vehicles of a platooning vehicles by group-casting a control message to another vehicle of the platooning vehicles via 5G enhanced-vehicle-to-everything (eV2X) communication.

In an embodiment, the driving threat analysis and control method can include the following steps.

In a step 105, the vehicle evaluates analysis efficiency of coloring for an adaptive cruise control (ACC), the lane departure warning (LDW), and a cooperative adaptive cruise control (CACC) and a cooperative autonomous platooning (CAP) system based on the driving state of the ADAS and a driving threat (AAT) mechanism. In a step 106, the vehicle uses different slicing flow priority for a change of the driving state of different ADAS. In a step 107, the vehicle changes the driving state of the ADAS in real time when the driving state of the ADAS is changed from a state i to a state j. In a step 108, the vehicle generates a uRLLC-Dangerous flow or a uRLLC-Warning flow via 5G enhanced-vehicle-to-everything (eV2X) when the driving state of the dynamic thresholds of the ADAS, the CACC, the LDW and the CAP is changed to a dangerous state in red color or a warning state in yellow color, by the vehicle.

According to above-mentioned contents, the difference between the present invention and the conventional technology is that a vehicle cloud based on cloud computing and mobile edge computing is applied to minimize and avoid dangerous and unstable driving action or self-driving vehicle (SDV), the CAP between the target vehicle and the front vehicle is applied to solve the problem that ACC easily generates a large number of state transitions, by collection of big data prediction of driving state information and 5G eV2X; the driving states of high-threat areas are analyzed by using 3-level cloud computing mechanism to reduce driving threats and realize active and safe driving of self-driving vehicles and assisted driving vehicles.

Therefore, the above-mentioned solution of the present invention is able to solve the conventional problem that the existing platooning vehicles still happen driving collision accidents, so as to achieve the efficiency of avoiding and preventing automated driving collisions and ensuring the safety of platooning vehicles driving autonomously.

The present invention disclosed herein has been described by means of specific embodiments. However, numerous modifications, variations and enhancements can be made thereto by those skilled in the art without departing from the spirit and scope of the disclosure set forth in the claims.

What is claimed is:

1. A driving threat analysis and control system based on driving state of advanced driver assist system, wherein the driving threat analysis and control system is adapted to a vehicle communicating via 5G and comprises:
a definition and classification module, configured to define and classify a driving state of each of advanced driver assistance systems (ADAS) based on sensed and gathered information of a neighbor vehicle;
a threshold setting module, configured to set a minimum safe distance between a target vehicle and a front vehicle, wherein the minimum safe distance and vehicle-following information of the target vehicle and the front vehicle are set as dynamic thresholds of the ADAS;
a threshold calculation module, configured to provide the dynamic thresholds to a lane departure warning (LDW) system and a lane departure assist (LDA) system, map a multiple-lane road to a single-lane road, determine a logical distance, switch the target vehicle and the front vehicle for using the same algorithm to determine optimal dynamic thresholds of the LDW system and the LDA system; and
a control message transmission module, configured to control velocities of all vehicles of platooning vehicles by group-casting a control message to another vehicle of the platooning vehicles via 5G enhanced-vehicle-to-everything (eV2X) communication.

2. The driving threat analysis and control system based on driving state of advanced driver assist system according to claim 1, wherein the vehicle comprises:
an evaluation and analysis module, configured to evaluate analysis efficiency of coloring for an adaptive cruise control (ACC), the lane departure warning (LDW), and a cooperative adaptive cruise control (CACC) and a cooperative autonomous platooning (CAP) system based on the driving state of the ADAS and a driving threat (AAT) mechanism;
a slicing flow selection module, configured to use different slicing flow priority for a change of the driving state of different ADAS for the vehicle;
a driving state transition module, configured to change the driving state of the ADAS in real time when the driving state of the ADAS is changed from a state i to a state j; and
a flow generation module, configured to generate a uRLLC-Dangerous flow or a uRLLC-Warning flow via 5G enhanced-vehicle-to-everything (eV2X) when the driving state of the dynamic thresholds of the ADAS, the CACC, the LDW and the CAP is changed to a dangerous state in red color or a warning state in yellow color.

3. The driving threat analysis and control system based on driving state of advanced driver assist system according to claim 1, wherein the dynamic thresholds comprises a dynamic threshold α and a dynamic threshold β, the dynamic threshold α is a minimum safe distance d_{i,j}^{ACC,α} between the target vehicle and the front vehicle, the dynamic threshold α is obtained by an equation as below,
$${d}_{i , j}^{ACC , α} ( t ) = {d}_{resp} ( t ) + {d}_{brake} ( t )$$
wherein the dynamic threshold β is obtained by an equation as below,
$${d}_{i , j}^{ACC , β} ( t ) = {d}_{i , j}^{ACC , α} ( t ) + {d}_{Adj}^{i , j} ( t )$$
wherein dᵣₑₛₚ(t) denotes a response distance required for a human driver (for ADAS Levels 1-3), or a detection distance of autonomous self-driving (ASD) vehicle (for ADAS Levels 4-5), d_{brake}(t) denotes a brake distance at time t, dᵣₑₛₚ(t) is the response distance obtained by an equation as below,
$${d}_{resp} ( t ) = {t}_{i}^{ACC} \cdot {v}_{i}^{r , ℓ} ( t ) .$$

4. The driving threat analysis and control system based on driving state of advanced driver assist system according to claim 1, wherein the logical distance is obtained by an equation as below,
$${d}_{i , j}^{LDW , Log} ( t ) = \sqrt{{{d}_{i , j}^{LDW , Phy} ( t )}^{2} - {( {W}_{r , i} )}^{2}}$$
wherein W_{r,l} denotes a lane width of a lane/on a road r.

5. The driving threat analysis and control system based on driving state of advanced driver assist system according to claim 1, wherein the optimal dynamic threshold α and the optimal dynamic threshold β for LDW/LDA are obtained by equations as below,
$${d}_{m , n}^{LDW , Log , α} ( t ) = \frac{{{v}_{m}^{r , ℓ + 1} ( t )}^{2}}{2 {u}^{r , l} {g}_{m}} + {t}_{i}^{LDW} \cdot {v}_{m}^{r , ℓ + 1} ( t )$$
$${d}_{m , n}^{LDW , Log , β} ( t ) = {d}_{m , n}^{LDW , Log , α} ( t ) + {d}_{Adj}^{m , n} ( t )$$
wherein d_{Adj}^{m,n}(t) denotes an adjustment distance, obtained by an equation as below,
$${d}_{Adj}^{m , n} ( t ) = {t}_{Adj}^{m , n} \cdot {v}_{n}^{r , ℓ} ( t )$$
wherein [symbol] (t) and [symbol] (t) denote a velocity of a rear vehicle V^{j} on a lane/+1 and a velocity of the front vehicle Vⁿ on the lane l, respectively, wherein the velocity V^{m} of the rear vehicle on the lane/+1 is determined by the velocity of the target vehicle on lane/and a relative velocity formula as below,
$${V}_{m}^{r , ℓ + 1} ( t ) ← {V}_{i}^{r , ℓ} ( t ) - {V}_{i , j}^{r} ( t ) .$$

6. A driving threat analysis and control method based on driving state of advanced driver assist system, wherein the driving threat analysis and control method is adapted to a vehicle communicating via 5G and comprises:
defining and classifying a driving state of each of advanced driver assistance systems (ADAS) based on sensed and gathered information of a neighbor vehicle, by the vehicle;
setting a minimum safe distance between a target vehicle and a front vehicle, by the vehicle, wherein the minimum safe distance and a vehicle-following information of the target vehicle and the front vehicle are set as dynamic thresholds of the ADAS;
providing the dynamic thresholds to a lane departure warning (LDW) system and a lane departure assist (LDA) system, mapping a multiple-lane road to a single-lane road, determine a logical distance, switching the target vehicle and the front vehicle for using the same algorithm to determine optimal dynamic thresholds of the LDW system and the LDA system, by the vehicle; and
controlling velocities of all vehicles of a platooning vehicles by group-casting a control message to another vehicle of the platooning vehicles via 5G enhanced-vehicle-to-everything (eV2X) communication, by the vehicle.

7. The driving threat analysis and control method based on driving state of advanced driver assist system according to claim 6, further comprising,
evaluating analysis efficiency of coloring for an adaptive cruise control (ACC), the lane departure warning (LDW), and a cooperative adaptive cruise control (CACC) and a cooperative autonomous platooning (CAP) system based on the driving state of the ADAS and a driving threat (AAT) mechanism, by the vehicle;
using different slicing flow priority for a change of the driving state of different ADAS, by the vehicle;
changing the driving state of the ADAS in real time when the driving state of the ADAS is changed from a state i to a state j, by the vehicle; and
generating a uRLLC-Dangerous flow or a uRLLC-Warning flow via 5G enhanced-vehicle-to-everything (eV2X) when the driving state of the dynamic thresholds of the ADAS, the CACC, the LDW and the CAP is changed to a dangerous state in red color or a warning state in yellow color, by the vehicle.

8. The driving threat analysis and control method based on driving state of advanced driver assist system according to claim 6, wherein the dynamic thresholds comprises a dynamic threshold α and a dynamic threshold β, the dynamic threshold α is a minimum safe distance d_{i,j}^{ACC,α} between the target vehicle and the front vehicle, the dynamic threshold α is obtained by an equation as below,
$${d}_{i , j}^{ACC , α} ( t ) = {d}_{resp} ( t ) + {d}_{brake} ( t )$$
wherein the dynamic threshold β is obtained by an equation as below,
$${d}_{i , j}^{ACC , β} ( t ) = {d}_{i , j}^{ACC , α} ( t ) + {d}_{Adj}^{i , j} ( t )$$
wherein dᵣₑₛₚ(t) denotes a response distance required for a human driver (for ADAS Levels 1-3), or a detection distance of autonomous self-driving (ASD) vehicle (for ADAS Levels 4-5), d_{brake}(t) denotes a brake distance at time t, dᵣₑₛₚ(t) is the response distance obtained by an equation as below,
$${d}_{resp} ( t ) = {t}_{i}^{ACC} \cdot {v}_{i}^{r , ℓ} ( t ) .$$

9. The driving threat analysis and control method based on driving state of advanced driver assist system according to claim 6, wherein the logical distance is obtained by an equation as below,
$${d}_{i , j}^{LDW , Log} ( t ) = \sqrt{{{d}_{i , j}^{LDW , Phy} ( t )}^{2} - {( {W}_{r , l} )}^{2}}$$
wherein W_{r,l} denotes a lane width of a lane/on a road r.

10. The driving threat analysis and control method based on driving state of advanced driver assist system according to claim 6, wherein the optimal dynamic threshold α and the optimal dynamic threshold β for LDW/LDA are obtained by equations as below,
$${d}_{m , n}^{LDW , Log , α} ( t ) = \frac{{{v}_{m}^{r , ℓ + 1} ( t )}^{2}}{2 {u}^{r , l} {g}_{m}} + {t}_{i}^{LDW} \cdot {v}_{m}^{r , ℓ + 1} ( t )$$
$${d}_{m , n}^{LDW , Log , β} ( t ) = {d}_{m , n}^{LDW , Log , α} ( t ) + {d}_{Adj}^{m , n} ( t )$$
wherein d_{Adj}^{m,n}(t) denotes an adjustment distance, obtained by an equation as below,
$${d}_{Adj}^{m , n} ( t ) = {t}_{Adj}^{m , n} \cdot {v}_{n}^{r , ℓ} ( t )$$
wherein [symbol] (t) and [symbol] (t) (t) denote a velocity of a rear vehicle V^{j} on a lane l+1 and a velocity of the front vehicle Vⁿ on the lane l, respectively, wherein the velocity V^{m} of the rear vehicle on the lane l+1 is determined by the velocity of the target vehicle on lane l and a relative velocity formula as below,
$${V}_{m}^{r , ℓ + 1} ( t ) ← {V}_{i}^{r , ℓ} ( t ) - {V}_{i , j}^{r} ( t ) .$$
